(19) United States
(12) Patent Application Publication
(10) Pub. No.: US 2019/0135247 A1
(43) Pub. Date: May 9, 2019

(54) SYSTEMS AND METHODS FOR BRAKING CONTROL

(71) Applicant: BEIJING DIDI INFINITY TECHNOLOGY AND DEVELOPMENT CO., LTD., Beijing (CN)

(72) Inventor: Wei LUO, Beijing (CN)

(73) Assignee: BEIJING DIDI INFINITY TECHNOLOGY AND DEVELOPMENT C O., LTD., Beijing (CN)

(21) Appl. No.: 16/236,279

(22) Filed: Dec. 28, 2018

Related U.S. Application Data
(63) Continuation of application No. PCT/CN2017/105818, filed on Oct. 12, 2017.

(51) Int. Cl. B60T 8/17; B60T 8/172; B60T 8/32

(52) U.S. Cl. CPC B60T 8/1701; B60T 2250/04; B60T 8/3205; B60T 8/172

(57) ABSTRACT

The present disclosure relates to systems and methods for determining a control parameter associated with a vehicle. The systems may perform the methods to determine a first reference acceleration at a first time point; determine a second reference acceleration at a second time point, wherein the first time point and the second time point are separated by a predetermined time period; obtain a correction coefficient by using a simulation model, which is configured to simulate operation of the vehicle; and determine a target acceleration at the second time point based on the first reference acceleration, the second reference acceleration, and the correction coefficient.

### CROSS-REFERENCE TO RELATED APPLICATIONS

This application claims priority to International Application No. PCT/CN2017/105818, filed on Oct. 12, 2017, which designates the United States of America, the contents of which are incorporated herein by reference in their entirety.

### TECHNICAL FIELD

The present disclosure generally relates to systems and methods for driverless technology, and in particular, to systems and methods for controlling a braking process associated with a driverless vehicle.

### BACKGROUND

With the development of micro-electronic technology and robot technology, driverless technology develops rapidly nowadays. For a control system of a driverless vehicle, it is important to stop the vehicle at a predetermined location precisely, automatically, and accurately. Commonly, the control system of the vehicle determines a control parameter (e.g., acceleration) based on instantaneous driving information (e.g., instantaneous speed) of the vehicle, and transmits the control parameter to a brake device of the vehicle to control the braking process. However, both the transmission process and the reaction of the brake device need time, resulting in a delay between the time point when the control parameter is determined and a time point when the brake device operates the vehicle. With such delay, it is hard to park the vehicle at the predetermined location accurately. Therefore, it is desirable to provide systems and methods for determining a corrected control parameter to overcome the effects of the delay and allow the driverless vehicle to stop at a predetermined location with a high level of precision and accuracy.

### SUMMARY

According to an aspect of the present disclosure, a system is provided. The system may include at least one storage medium and at least one processor in communication with the at least one storage medium. The at least one storage medium may include a set of instructions for determining a control parameter associated with a vehicle. When the at least one storage medium executes the set of instructions, the at least one processor may be configured to cause the system to perform one or more of the following operations. The at least one processor may determine a first reference acceleration at a first time point and determine a second reference acceleration at a second time point, wherein the first time point and the second time point are separated by a predetermined time period. The at least one processor may obtain a correction coefficient by using a simulation model, which may be configured to simulate operation of the vehicle. The at least one processor may determine a target acceleration at the second time point based on the first reference acceleration, the second reference acceleration, and/or the correction coefficient.

According to another aspect of the present disclosure, a method is provided. The method may be implemented on a computing device having at least one processor, at least one storage medium, and a communication platform connected to a network. The method may include one or more of the following operations. The at least one processor may determine a first reference acceleration at a first time point and determine a second reference acceleration at a second time point, wherein the first time point and the second time point are separated by a predetermined time period. The at least one processor may obtain a correction coefficient by using a simulation model, which may be configured to simulate operation of the vehicle. The at least one processor may determine a target acceleration at the second time point based on the first reference acceleration, the second reference acceleration, and/or the correction coefficient.

According to yet another aspect of the present disclosure, a non-transitory computer-readable storage medium is provided. The non-transitory computer-readable storage medium may include a set of instructions for determining a control parameter associated with a vehicle. When the set of instructions is executed by at least one processor, the set of instructions may direct the at least one processor to perform one or more of the following operations. The at least one processor may determine a first reference acceleration at a first time point and determine a second reference acceleration at a second time point, wherein the first time point and the second time point are separated by a predetermined time period. The at least one processor may obtain a correction coefficient by using a simulation model, which may be configured to simulate operation of the vehicle. The at least one processor may determine a target acceleration at the second time point based on the first reference acceleration, the second reference acceleration, and/or the correction coefficient.

In some embodiments, the at least one processor may further transmit the target acceleration to a control component of the vehicle to prompt the control component to adjust an actual acceleration of the vehicle.

In some embodiments, the at least one processor may determine a candidate correction coefficient based on the simulation model, which may be configured with one or more features of the vehicle. The at least one processor may obtain at least one test result associated with the candidate correction coefficient with a test vehicle having similar one or more features. The at least one processor may determine the correction coefficient by modifying the candidate correction coefficient based on the at least one test result.

In some embodiments, the one or more features of the vehicle may include at least one of vehicle type, vehicle model, vehicle weight, vehicle year, engine power, and/or brake efficiency.

In some embodiments, the simulation model may be further configured with at least one of the predetermined time period, a road condition and/or weather.

In some embodiments, the at least one test result associated with the test vehicle includes at least one of a test initial speed of the test vehicle, a test start location, a test destination, an actual parking location, and/or an offset distance between the test destination and the actual parking location.

In some embodiments, the correction coefficient is self-adaptive.

In some embodiments, the at least one processor may determine a first speed of the vehicle at the first time point. The at least one processor may obtain a first location of the vehicle at the first time point. The at least one processor may determine a first distance between the first location and a destination. The at least one processor may determine the first reference acceleration at the first time point based on the first speed and the first distance.

In some embodiments, the at least one processor may determine a second speed of the vehicle at the second time point. The at least one processor may obtain a second location of the vehicle at the second time point. The at least one processor may determine a second distance between the second location and a destination. The at least one processor may determine the second reference acceleration at the second time point based on the second speed and the second distance.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary automatic braking system associated with a vehicle according to some embodiments of the present disclosure;

FIG. 2 is a schematic diagram illustrating exemplary hardware and software components of a computing device according to some embodiments of the present disclosure;

FIG. 3 is a block diagram illustrating an exemplary processing engine according to some embodiments of the present disclosure;

FIG. 4 is a flowchart illustrating an exemplary process for determining a control parameter associated with a vehicle according to some embodiments of the present disclosure;

FIG. 5 is a block diagram illustrating an exemplary determination module according to some embodiments of the present disclosure;

FIG. 6 is a flowchart illustrating an exemplary process for determining a target acceleration according to some embodiments of the present disclosure;

FIG. 7 is a schematic diagram illustrating an exemplary automatic braking process according to some embodiments of the present disclosure;

FIG. 8 is a block diagram illustrating an exemplary correction coefficient determination unit according to some embodiments of the present disclosure; and

FIG. 9 is a flowchart illustrating an exemplary process for determining a correction coefficient according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding controlling a braking process of a car, it should be understood that this is only one exemplary embodiment. The systems or methods of the present disclosure may be applied to any other kind of control system of a vehicle. For example, the systems or methods of the present disclosure may be applied to transportation systems of different environments including land, ocean, aerospace, or the like, or any combination thereof. The vehicle may include a taxi, a private car, a hitch, a bus, a train, a bullet train, a high-speed rail, a subway, a vessel, an aircraft, a spaceship, a hot-air balloon, a driverless vehicle, or the like, or a combination thereof.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for controlling a parking process associated with a driverless vehicle. Here, “parking” is broadly referring to the process or action that the vehicle is heading towards, and/or stopping at, a particular location. The systems and methods may obtain driving information (e.g., a speed of the vehicle, a distance between a current location of the vehicle and a predetermined parking location, etc.) of the vehicle at a predetermined time interval (e.g., 20 ms), and determine a control parameter (e.g., an acceleration) based on the driving information. Here, “acceleration” is broadly referring to the change of speed (both increasing and decreasing) and/or change of direction. Further, the systems and methods may transmit the control parameter to a control component of the vehicle to prompt the control component to adjust an actual acceleration of the vehicle.

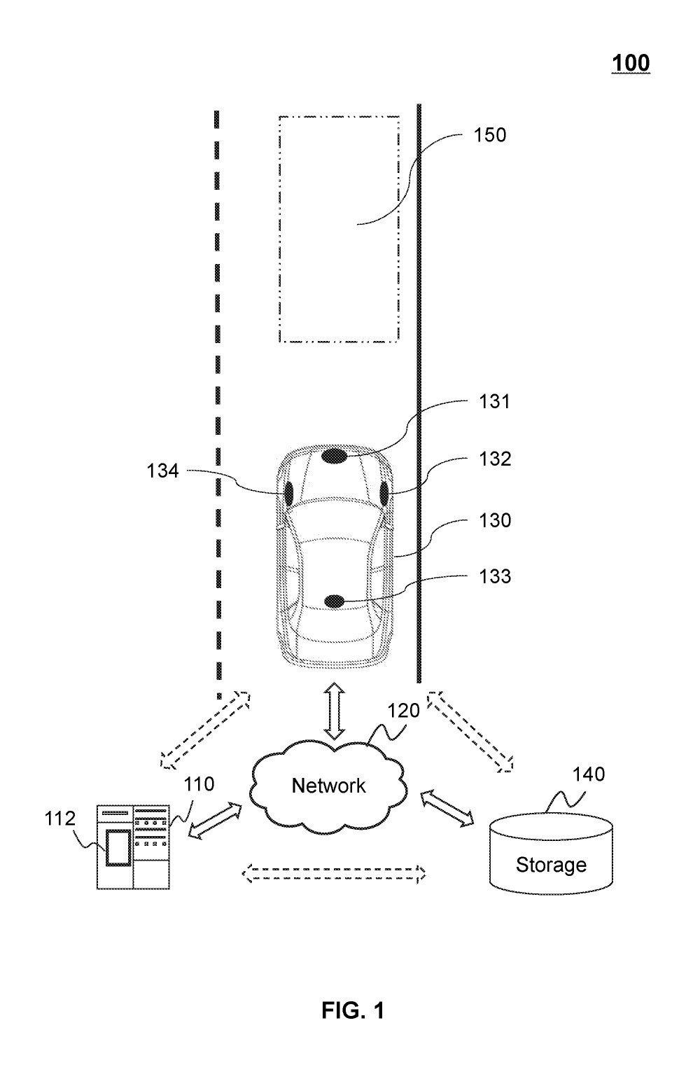

FIG. 1 is a schematic diagram illustrating an exemplary automatic control system 100 associated with a vehicle according to some embodiments of the present disclosure. In some embodiments, the automatic control system 100 may include a server 110, a network 120, a vehicle 130, and a storage 140.

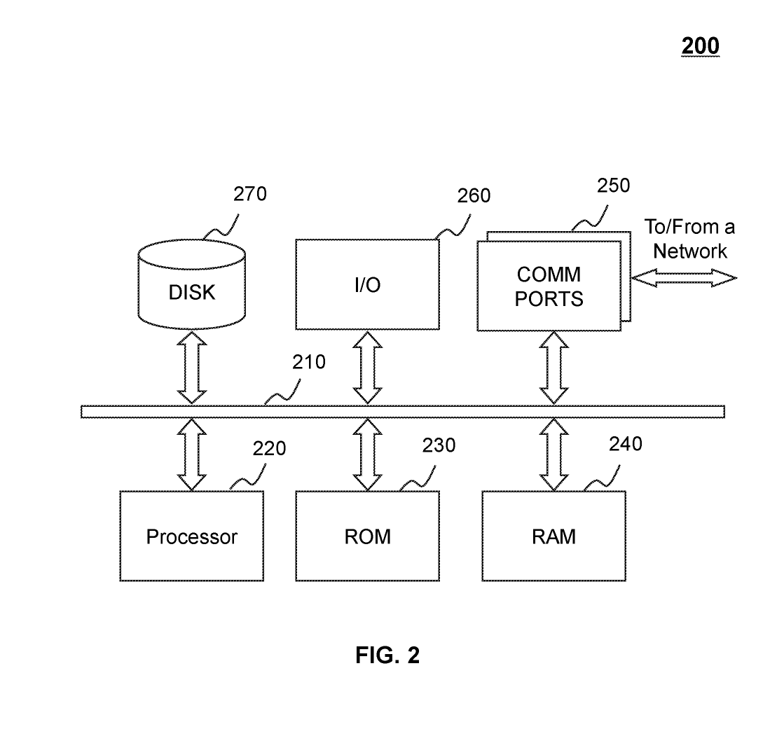

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the vehicle 130 and/or the storage 140 via the network 120. As another example, the server 110 may be directly connected to the vehicle 130 and/or the storage 140 to access stored information and/or data. In some embodiments, the server 110 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data associated with driving information of the vehicle 130 to perform one or more functions described in the present disclosure. For example, the processing engine 112 may obtain driving information of the vehicle 130 and determine a control parameter which may be used to control the vehicle 130 based on the driving information. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the server 110 may be connected to the network 120 to communicate with one or more components of the automatic control system 100 (e.g., the vehicle 130 and the storage 140). In some embodiments, the server 110 may be directly connected to or communicate with one or more components in the automatic control system 100 (e.g., the vehicle 130 and the storage 140). In some embodiments, the server 110 may be integrated in the vehicle 130.

The network 120 may facilitate exchange of information and/or data. In some embodiments, one or more components in the automatic control system 100 (e.g., the server 110, the vehicle 130, or the storage 140) may send information and/or data to other component(s) in the automatic control system 100 via the network 120. For example, the server 110 may obtain/acquire driving information of the vehicle 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points, through which one or more components of the automatic control system 100 may be connected to the network 120 to exchange data and/or information.

The vehicle 130 may include structures of a conventional vehicle, for example, a chassis, a suspension, a steering wheel, a drivetrain component, an engine, etc. The vehicle 130 may also include a plurality of sensors (e.g., a distance sensor 131, a speed sensor 132, a location sensor 133, etc.), a brake device 134, an accelerator (not shown), etc. In some embodiments, the plurality of sensors may detect driving information of the vehicle 130. For example, the location sensor 133 may periodically (e.g., per 20 ms) detect a current location of the vehicle 130. As another example, the distance sensor 131 may detect a distance between the current location of the vehicle 130 and a defined location (e.g., a destination 150). As a further example, the distance sensor 131 may detect a distance between the current location of the vehicle 130 and other vehicles nearby. As a still further example, the speed sensor 132 may detect an instantaneous speed of the vehicle 130.

In some embodiments, the distance sensor 131 may include a radar, a lidar, an infrared sensor, or the like, or a combination thereof. The speed sensor 132 may include a Hall sensor. In some embodiments, the plurality of sensors may also include an acceleration sensor (e.g., an accelerometer), a steering angle sensor (e.g., a tilt sensor), a traction-related sensor (e.g., a force sensor), and/or any sensor configured to detect information associated with dynamic situation of the vehicle 130.

The brake device 134 may be configured to control a braking process of the vehicle 130. For example, the brake device 134 may adjust an actual acceleration of the vehicle based on an instruction including a target acceleration obtained from the processing engine 112. The accelerator may be configured to control an accelerating process of the vehicle 130.

The storage 140 may store data and/or instructions. In some embodiments, the storage 140 may store data obtained from the vehicle 130, such as driving information acquired by the plurality of sensors. In some embodiments, the storage 140 may store data and/or instructions that the server 110 may execute or use to perform exemplary methods described in the present disclosure. In some embodiments, the storage 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 140 may be connected to the network 120 to communicate with one or more components of the automatic control system 100 (e.g., the server 110 and the vehicle 130). One or more components in the automatic control system 100 may access the data or instructions stored in the storage 140 via the network 120. In some embodiments, the storage 140 may be directly connected to or communicate with one or more components in the automatic control system 100 (e.g., the server 110 and the vehicle 130). In some embodiments, the storage 140 may be part of the server 110.

FIG. 2 is a schematic diagram illustrating an exemplary hardware and software components of a computing device on which the server 110 may be implemented according to some embodiments of the present disclosure. For example, the processing engine 112 may be implemented on the computing device 200 and configured to perform functions of the processing engine 112 disclosed in this disclosure.

The computing device 200 may be used to implement the automatic control system 100 of the present disclosure. For example, the processing engine 112 of the automatic control system 100 may be implemented on the computing device 200, via its hardware, software program, firmware, or a combination thereof. Although only one such computer is shown for convenience, the computer functions related to the automatic control system 100 as described herein may be implemented in a distributed manner on a number of similar platforms to distribute the processing load.

The computing device 200, for example, may include communication (COMM) ports 250 connected to and from a network (e.g., network 120) connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device 200 may further include program storage and data storage of different forms, for example, a disk 270, and a read only memory (ROM) 230, or a random access memory (RAM) 240, for various data files to be processed and/or transmitted by the computing device 200. The exemplary computing device 200 may also include program instructions stored in the ROM 230, the RAM 240, and/or other type of non-transitory storage medium to be executed by the processor 220. The methods and/or processes of the present disclosure may be implemented as the program instructions. The computing device 200 also includes an I/O component 260, supporting input/output between the computing device 200 and other components therein. The computing device 200 may also receive programming and data via network communications.

Merely for illustration, only one processor is described in the computing device 200. However, it should be noted that the computing device 200 in the present disclosure may also include multiple processors, and thus operations that are performed by one processor as described in the present disclosure may also be jointly or separately performed by the multiple processors. For example, the processor of the computing device 200 executes both operation A and operation B. As in another example, operation A and operation B may also be performed by two different processors jointly or separately in the computing device 200 (e.g., the first processor executes operation A and the second processor executes operation B, or the first and second processors jointly execute operations A and B).

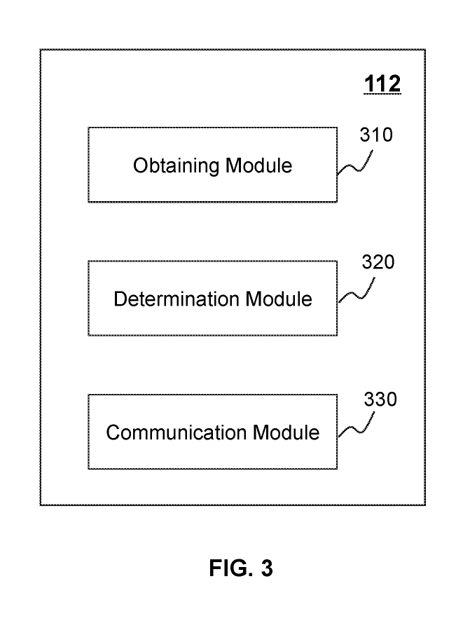

FIG. 3 is a block diagram illustrating an exemplary processing engine according to some embodiments of the present disclosure. The processing engine 112 may include an obtaining module 310, a determination module 320, and a communication module 330.

The obtaining module 310 may be configured to obtain driving information of a vehicle (e.g., the vehicle 130). In some embodiments, the obtaining module 310 may periodically (e.g., per 5 ms, 10 ms, 20 ms, 30 ms, 50 ms, or 100 ms) obtain the driving information. In some embodiments, the obtaining module 310 may obtain the driving information from one or more sensors (e.g., the distance sensor 131, the speed sensor 132, the location sensor 133, etc.) in the vehicle 130. In some embodiments, the obtaining module 310 may obtain the driving information from a storage device (e.g., the storage 140) disclosed elsewhere in the present disclosure. In some embodiments, the obtaining module 310 may obtain the instantaneous driving information. In some embodiments, the obtaining module 310 may obtain the historical driving information. In some embodiments, the driving information may include a speed of the vehicle 130 (e.g., an instantaneous speed), a current location of the vehicle 130, a distance between the current location of the vehicle 130 and the destination 150 (e.g., a predetermined parking location), etc. In some embodiments, the driving information may further include an acceleration of the vehicle 130 (e.g., an instantaneous acceleration), a steering angle of the vehicle 130, etc.

The determination module 320 may be configured to determine a control parameter based on the driving information. For example, the determination module 320 may determine a target acceleration which may be used to brake the vehicle 130 based on the speed of the vehicle 130 and the distance between the current location and the predetermined parking location. As used herein, the target acceleration refers to a braking control parameter upon which the brake device 134 may adjust an actual acceleration of the vehicle 130. For example, the brake device 134 may control the operation of a brake pad to adjust the actual acceleration of the vehicle 130 to reach and/or maintain the target acceleration. The target acceleration may indicate a speed change of the vehicle 130. The target acceleration may be a positive acceleration or a negative acceleration (i.e., a deceleration). The determination module 320 may determine the target acceleration at a predetermined time period (e.g., 20 ms).

The communication module 330 may be configured to exchange information and/or data between the processing engine 112 and a control component (e.g., the brake device 134) of the vehicle 130. For example, the communication module 330 may transmit the target acceleration to the brake device 134 to brake the vehicle 130. In certain embodiments, the communication module 330 may transmit the target acceleration to a power-producing part (e.g., engine) of the vehicle 130 to adjust the actual acceleration.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the obtaining module 310 and the determination module 320 may be combined as a single module which may both obtain the driving information and determine the control parameter based on the driving information. As another example, the processing engine 112 may include a storage module (not shown) used to store information and/or data associated with the vehicle (e.g., the driving information, the control parameter).

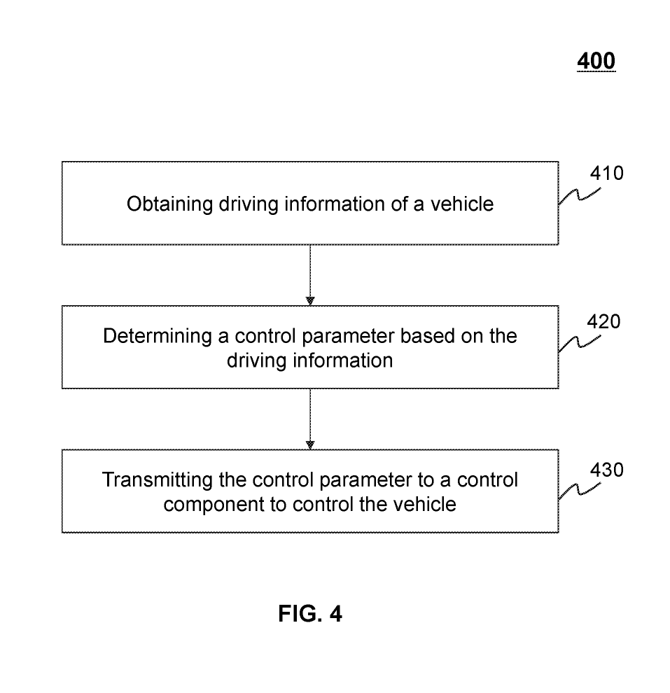

FIG. 4 is a flowchart illustrating an exemplary process for determining a control parameter associated with a vehicle according to some embodiments of the present disclosure. The process 400 may be executed by the automatic control system 100. For example, the process 400 may be implemented as a set of instructions stored in the storage ROM 230 or RAM 240. The processor 220 and/or the modules in FIG. 3 may execute the set of instructions, and when executing the instructions, it may be configured to perform the process 400. The operations of the illustrated process presented below are intended to be illustrative. In some embodiments, the process 400 may be accomplished with one or more additional operations not described and/or without one or more of the operations discussed. Additionally, the order in which the operations of the process 400 as illustrated in FIG. 4 and described below is not intended to be limiting.

In step 410, the processing engine 112 (e.g., the obtaining module 310) (e.g., the interface circuits of the processor 220) may obtain driving information of a vehicle (e.g., the vehicle 130). The processing engine 112 may periodically (i.e., every time after a predetermined time period (e.g., every 20 ms)) obtain the driving information. In some embodiments, the driving information may include a speed of the vehicle 130 (e.g., an instantaneous speed), a current location of the vehicle 130, a distance between the current location of the vehicle 130 and the destination 150 (e.g., a predetermined parking location), etc. In some embodiments, the driving information may further include an acceleration of the vehicle 130 (e.g., an instantaneous acceleration), a steering angle of the vehicle 130, etc. In some embodiments, the processing engine 112 may obtain the driving information from the plurality of sensors (e.g., the distance sensor 131, the speed sensor 132, the location sensor 133, etc.). In some embodiments, the processing engine 112 may obtain the driving information from a storage device (e.g., the storage 140) disclosed elsewhere in the present disclosure.

In step 420, the processing engine 112 (e.g., the determination module 320) (e.g., the processing circuits of the processor 220) may determine a control parameter based on the driving information. For example, the processing engine 112 may determine a target acceleration which may be used to brake the vehicle 130 based on the speed of the vehicle 130 and the distance between the current location and the predetermined parking location. As used herein, the target acceleration refers to a braking control parameter upon which the brake device 134 may adjust an actual acceleration of the vehicle 130. For example, the brake device 134 may control the operation of a brake pad to adjust the actual acceleration of the vehicle 130 to reach and/or maintain the target acceleration. As described in connection with step 410, the processing engine 112 may periodically (e.g., per 20 ms) determine the control parameter based on the driving information.

In step 430, the processing engine 112 (e.g., the communication module 330) (e.g., the interface circuits of the processor 220) may transmit the control parameter to a control component to control the vehicle 130. For example, the processing engine 112 may transmit the target acceleration to the brake device 134 to prompt the brake device 134 to adjust an actual acceleration of the vehicle 130. In certain embodiments, the processing engine 112 may transmit the target acceleration to a power-producing part (e.g., engine) of the vehicle 130 to adjust the actual acceleration.

For illustration purposes, the present disclosure describes a braking process as an example, it should be noted that the processing engine 112 may determine a control parameter associated with an accelerating process and transmit the control parameter to the accelerator to control the accelerating process.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 400. In the storing step, the processing engine 112 may store information and/or data associated with the vehicle (e.g., the driving information, the control parameter) in a storage device (e.g., the storage 140) disclosed elsewhere in the present disclosure.

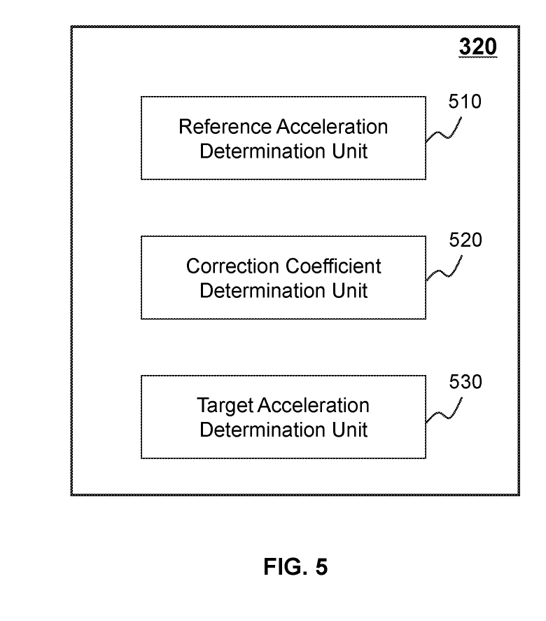

FIG. 5 is a block diagram illustrating an exemplary determination module according to some embodiments of the present disclosure. The determination module 320 may include a reference acceleration determination unit 510, a correction coefficient determination unit 520, and a target acceleration determination unit 530.

The reference acceleration determination unit 510 may be configured to determine a reference acceleration at a time point associated with the vehicle 130. As used herein, the reference acceleration refers to an ideal acceleration upon which the control component (e.g., brake device 134) can control the vehicle 130 to accurately stop at the predetermined parking location. In other words, for any time point during the braking process, if the control component can adjust an actual acceleration of the vehicle 130 at the time point to equal to the ideal acceleration, the vehicle 130 can accurately stop at the predetermined parking location.

In some embodiments, the reference acceleration determination unit 510 may determine the reference acceleration at a time point based on the driving information (e.g., an instantaneous speed of the vehicle 130 at the time point, a distance between a current location of the vehicle 130 and the destination 150 at the time point, etc.) of the vehicle 130. In some embodiments, the reference acceleration determination unit 510 may determine the reference acceleration every time after a predetermined time period (e.g., every 20 ms).

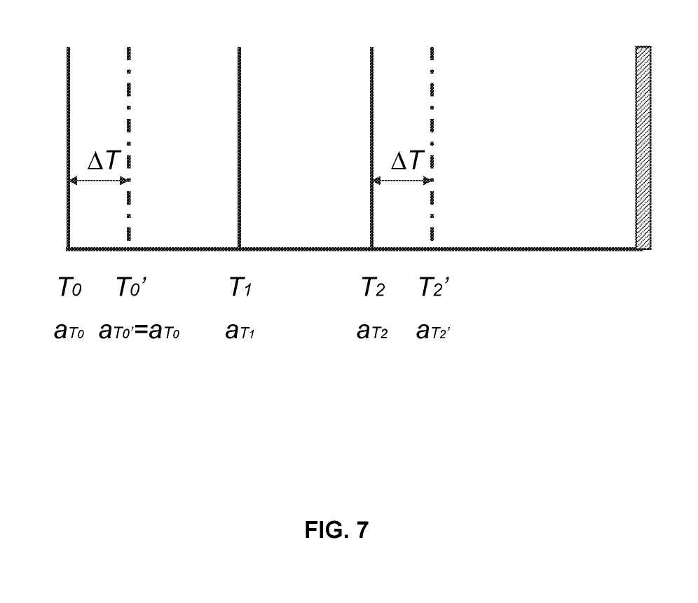

The correction coefficient determination unit 520 may be configured to determine a correction coefficient. In some embodiments, the correction coefficient may be used to determine a target acceleration which may be transmitted to the control component (e.g., the brake device 134) to control the vehicle 130. In some embodiments, it is known that both a transmission process for transmitting a determined acceleration (e.g., an ideal acceleration) to the control component and the reaction of the control component need some time (here, we can assume that the time that the process for determining the acceleration needs is almost zero), which results in a time delay (e.g., ΔT illustrated in FIG. 7) between the time point when the acceleration is determined and a time point when the control component operates the vehicle 130. Therefore, the processing engine 112 introduces the correction coefficient and determines a corrected acceleration (i.e., a target acceleration) based on the correction coefficient, wherein the target acceleration approximates to an ideal acceleration at a time point when the control component (e.g., the brake device 134) operates the vehicle 130 (e.g., see, FIG. 7 and the description thereof).

In some embodiments, the correction coefficient determination unit 520 may determine the correction coefficient by using a simulation model. For example, the correction coefficient determination unit 520 may simulate operation of the vehicle 130 based on one or more features (e.g., vehicle type, vehicle weight, vehicle model, vehicle year, etc.) and determine the correction coefficient based on the simulation results. In some embodiments, the correction coefficient determination unit 520 may further modify the correction coefficient based on one or more test results. In some embodiments, the correction coefficient may be fixed during a predetermined time interval (e.g., 1 year) or may be adjustable under different situations. For example, the correction coefficient determination unit 520 may update the correction coefficient at a predetermined time interval (e.g., 1 month, 2 months, 1 year, etc.) based on a newly performed simulation and/or a newly obtained test result.

The target acceleration determination unit 530 may be configured to determine a target acceleration based on the reference acceleration and the correction coefficient. For example, the target acceleration determination unit 530 may determine the target acceleration based on a first reference acceleration at a first time point, a second reference acceleration at a second time point, and the correction coefficient, wherein the second time point and the first time point is separated by the predetermined time period (e.g., 20 ms).

The units in the determination module 320 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the units may be combined into a single module, and any one of the modules may be divided into two or more sub-units. For example, the reference acceleration determination unit 510 and the correction coefficient determination unit 520 may be combined as a single module which may both determine the reference acceleration and the correction coefficient. As another example, the determination module 320 may include a storage unit (not shown) used to store information and/or data associated with the vehicle 130 (e.g., the reference acceleration, the correction coefficient, the target acceleration, etc.).

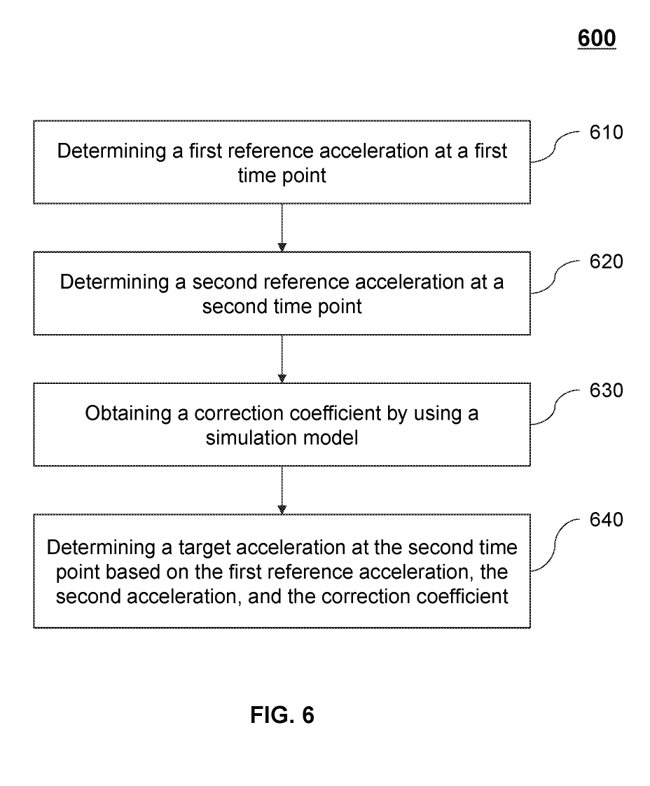

FIG. 6 is a flowchart illustrating an exemplary process for determining a target acceleration according to some embodiments of the present disclosure. The process 600 may be executed by the automatic control system 100. For example, the process 600 may be implemented as a set of instructions stored in the storage ROM 230 or RAM 240. The processor 220 and/or the units in FIG. 5 may execute the set of instructions, and when executing the instructions, it may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process as illustrated in FIG. 6 and described below is not intended to be limiting.

In step 610, the processing engine 112 (e.g., the reference acceleration determination 510) (e.g., the processing circuits of the processor 220) may determine a first reference acceleration at a first time point (e.g., a time point T₁ illustrated in FIG. 7). For example, the processing engine 112 may determine the first acceleration at the first time point according to formula (1) below:

$${a}_{T 1} = \frac{{v}_{T 1}^{2}}{2 {D}_{T 1}} \qquad ( 1 )$$

where a_{T1} refers to the first reference acceleration at the first time point, v_{T1} refers to an instantaneous speed of the vehicle 130 at the first time point, and D_{T1} refers to a distance between a current location of the vehicle 130 and the destination 150 (e.g., a predetermined parking location) at the first time point. As used herein, the reference acceleration refers to an ideal acceleration upon which the control component (e.g., brake device 134) can control the vehicle 130 to accurately stop at the predetermined parking location.

In step 620, the processing engine 112 (e.g., the reference acceleration determination unit 510) (e.g., the processing circuits of the processor 220) may determine a second reference acceleration at a second time point (e.g., a time point T₂ illustrated in FIG. 7). The second time point and the first time point may be separated by the predetermined time period (e.g., 20 ms). For example, the processing engine 112 may determine the second acceleration at the second time point according to formula (2):

$${a}_{T 2} = \frac{{v}_{T 2}^{2}}{2 {D}_{T 2}} \qquad ( 2 )$$

where a_{T2} refers to the second reference acceleration at the second time point, v_{T2} refers to an instantaneous speed of the vehicle 130 at the second time point, and D_{T2} refers to a distance between a current location of the vehicle 130 and the destination 150 at the second time point.

In step 630, the processing engine 112 (e.g., the correction coefficient determination unit 520) (e.g., the processing circuits of the processor 220) may obtain a correction coefficient. As described in connection with FIG. 5, the correction coefficient may be used to determine a target acceleration which may be transmitted to the control component (e.g., the brake device 134) to control the vehicle 130.

In some embodiments, the processing engine 112 may obtain the correction coefficient by using a simulation model which is configured to simulate operation of the vehicle 130. For example, the processing engine 112 may simulate operation of the vehicle 130 based on one or more features (e.g., vehicle type, vehicle weight, vehicle model, vehicle year, etc.) and determine the correction coefficient based on the simulation results. In some embodiments, the processing engine 112 may further modify the correction coefficient based on one or more test results. In some embodiments, the correction coefficient may be fixed during a predetermined time interval (e.g., 1 year) or may be adjustable under different situations. For example, the processing engine 112 may update the correction coefficient at a predetermined time interval (e.g., 1 month, 2 months, 1 year, etc.) based on a newly performed simulation and/or a newly obtained test result.

In step 640, the processing engine 112 (e.g., the target acceleration determination unit 530) (e.g., the processing circuits of the processor 220) may determine a target acceleration at the second time point based on the first reference acceleration, the second reference acceleration, and the correction coefficient. For example, the processing engine 112 may determine the target acceleration according to formula (3) below:

a′_{T2}=ηa_{T1}+(1−η)a_{T2} (3)

where a_{T2} refers to the target acceleration at the second time point, η refers to the correction coefficient, a_{T1} refers to the first reference acceleration at the first time point, and a_{T2} refers to the second reference acceleration at the second time point.

In some embodiments, for a start time point (e.g., T₀ illustrated in FIG. 7) when the processing engine 112 determines to start changing speed (e.g., starting a braking process), the processing engine 112 may determine an acceleration according to formula (1) or formula (2) as the target acceleration.

Further, as described in connection with step 430, the processing engine 112 may transmit the target acceleration to the control component (e.g., the brake device 134) of the vehicle 130 to prompt the control component to adjust an actual acceleration of the vehicle 130.

For illustration purposes, the present disclosure describes a specific target acceleration at the second time point as an example, it should be noted that the processing engine 112 may periodically (i.e., every time after the predetermined time period (e.g., every 20 ms)) determine a plurality of target accelerations and transmit to the control component to control the braking process of the vehicle 130.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the correction coefficient may be default settings of the system 100.

FIG. 7 is a schematic diagram illustrating an exemplary braking process according to some embodiments of the present disclosure. As illustrated, T₀ refers to a start time point when the processing engine 112 determines to start changing speed (e.g., starting a braking process). The processing engine 112 may obtain an instantaneous speed of the vehicle 130 and a distance between a current location of the vehicle 130 and the destination 150, and determine a reference acceleration (i.e., a_{T0}, an ideal acceleration) at the start time point (e.g., according to formula (1) or formula (2)) as a target acceleration (i.e., a_{T0}′). Further, the processing engine 112 may transmit the target acceleration to the control component (e.g., the brake device 134). After receiving the target acceleration, the control component may analyze the target acceleration and operates the vehicle 130 based on the target acceleration at a time point T₀′.

As described in connection with FIG. 6, T₁ refers to the first time point, T₂ refers to the second time point, and the second time point and the first time point are separated by the predetermined time period (e.g., 5 ms, 10 ms, 20 ms, 30 ms, 50 ms, or 100 ms). The processing engine 112 may determine a target acceleration (i.e., a_{T2}′) at the second time point (e.g., according to formula (3)) and transmit the target acceleration to the control component. After receiving the target acceleration, the control component may analyze the target acceleration and operates the vehicle 130 based on the target acceleration at a time point T₂′.

As illustrated, it can be seen that there is a time delay (i.e., ΔT) between the time point when the processing engine 112 determines the target acceleration and the time point when the control component operates the vehicle 130. Therefore, in some embodiments, the processing engine 112 introduces the correction coefficient (e.g., see, description disclosed elsewhere in the present disclosure) which can make the target acceleration approximate an ideal acceleration at the time point when the control component operates the vehicle 130. In certain embodiments, the target acceleration is infinitely or immeasurable close to the ideal acceleration, ensuring that the vehicle can stop precisely and accurately at the predetermined location.

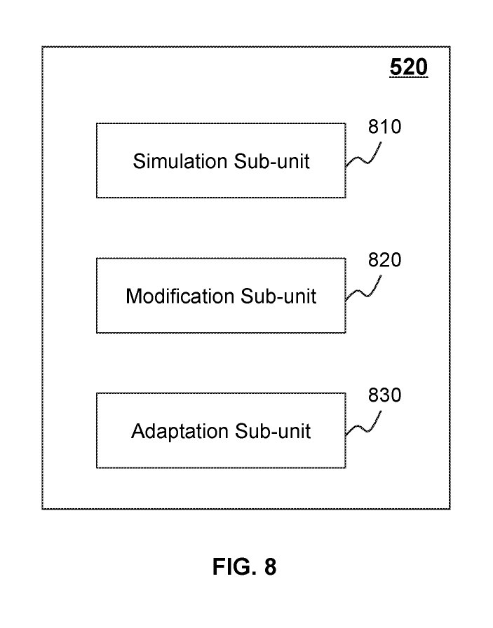

FIG. 8 is a block diagram illustrating an exemplary correction coefficient determination unit according to some embodiments of the present disclosure. The correction coefficient determination unit 520 may include a simulation sub-unit 810, a modification sub-unit 820, and an adaptation sub-unit 830.

The simulation sub-unit 810 may be configured to determine a candidate correction coefficient based on a simulation model which is configured to simulate operation of the vehicle 130. The simulation sub-unit 810 may obtain the simulation model from a storage device (e.g., the storage 140) disclosed elsewhere in the present disclosure. The simulation model may be configured with one or more features of the vehicle 130, such as vehicle type, vehicle model, vehicle year, vehicle weight, engine power, brake efficiency, etc. In some embodiments, the simulation model may be further configured with parameters such as but not limited to the predetermined time period (e.g., 20 ms) between the first time point and the second time point, road condition, weather, etc. Such parameters can be adjusted to make the simulation more complete. The simulation sub-unit 810 may simulate a braking process of the vehicle 130 based on the simulation model and determine the candidate correction coefficient based on the simulation results.

The modification sub-unit 820 may be configured to determine a target correction coefficient by modifying the candidate correction coefficient based on at least one test result associated with the candidate correction coefficient with a test vehicle having one or more similar features with the vehicle 130. In certain embodiments, the test vehicle has similar vehicle type, vehicle model, vehicle year, vehicle weight, engine power, and/or brake efficiency as the vehicle 130. In some embodiments, the test result may include a test initial speed of the test vehicle, a test start location of the test vehicle, a test destination, an actual parking location, an offset distance between the actual parking location and the test destination, etc. In certain embodiments, the target correction coefficient is determined as the correction coefficient to minimize the difference between the test results and the results from the simulation model. In certain embodiments, multiple test results are needed to improve the reliability of the modification.

The adaptation sub-unit 830 may be configured to adaptively adjust the correction coefficient. For example, in practice, the adaptation sub-unit 830 may adaptively adjust the correction coefficient based on vehicle information, driving information, driving control information (e.g., a difference between an actual parking location and a predetermined parking location), or the like, or a combination thereof. The adaptation sub-unit 830 may adjust the correction coefficient based on a zero-forcing algorithm, steepest descent algorithm, least mean square (LMS) algorithm, etc.

The sub-units in the correction coefficient determination unit 520 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the sub-units may be combined into a single unit, and any one of the sub-units may be divided into two or more blocks. For example, the simulation sub-unit 810 and the modification sub-unit 820 may be combined as a single unit which may both determine a candidate correction coefficient and determine a target correction coefficient by modifying the candidate correction coefficient based on at least one test result. As another example, the correction coefficient determination unit 520 may include a storage sub-unit (not shown) used to store information and/or data associated with the correction coefficient (e.g., the simulation model, the candidate correction coefficient, the test result, the target correction coefficient, etc.).

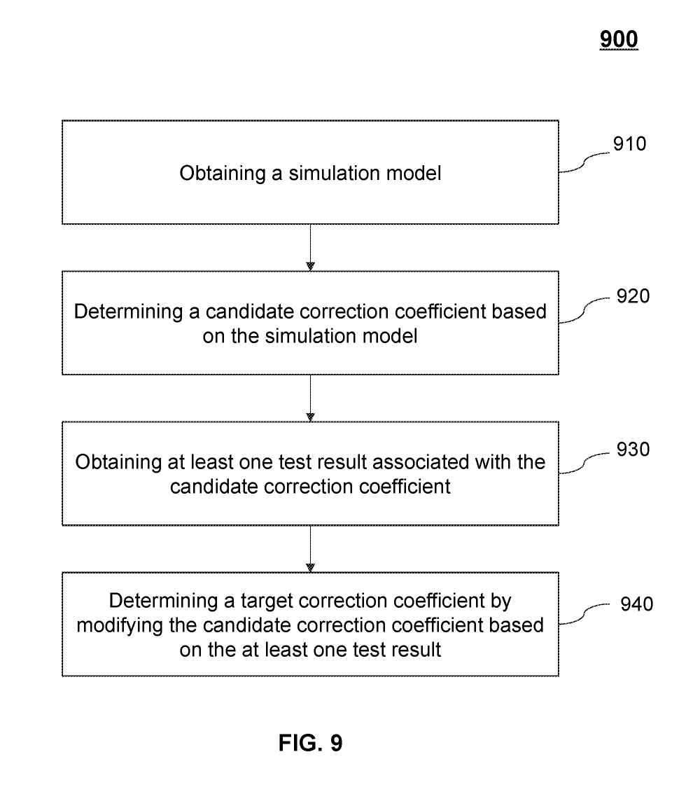

FIG. 9 is a flowchart illustrating an exemplary process for determining a correction coefficient according to some embodiments of the present disclosure. The process 900 may be executed by the automatic control system 100. For example, the process 900 may be implemented as a set of instructions stored in the storage ROM 230 or RAM 240. The processor 220 and/or the sub-units in FIG. 8 may execute the set of instructions, and when executing the instructions, it may be configured to perform the process 900. The operations of the illustrated process presented below are intended to be illustrative. In some embodiments, the process 900 may be accomplished with one or more additional operations not described and/or without one or more of the operations discussed. Additionally, the order in which the operations of the process 900 as illustrated in FIG. 9 and described below is not intended to be limiting.

In step 910, the processing engine 112 (e.g., the simulation sub-unit 810) (e.g., the interface circuits of the processor 220) may obtain a simulation model which is configured to simulate operation of the vehicle 130. The simulation sub-unit 810 may obtain the simulation model from a storage device (e.g., the storage 140) disclosed elsewhere in the present disclosure.

In step 920, the processing engine 112 (e.g., the simulation sub-unit 810) (e.g., the processing circuits of the processor 220) may determine a candidate correction coefficient based on the simulation model. In some embodiments, the simulation model may be configured with one or more features (e.g., vehicle type, vehicle weight, vehicle model, vehicle year, engine power, brake efficiency, etc.) of the vehicle 130. The processing engine 112 may simulate the operation of the vehicle 130 (e.g., a braking process of the vehicle 130) based on the features according to the simulation model. In some embodiments, the simulation model may be further configured with the predetermined time period (e.g., 20 ms), road condition, weather, etc. Such parameters can be adjusted to make the simulation more complete.

For example, the processing engine 112 may determine an initial correction coefficient (e.g., 0) and simulate a braking process of the vehicle 130 based on the initial coefficient. Further, the processing engine 112 may iteratively update the initial correction coefficient based on a plurality of simulation results until a predetermined condition is satisfied, for example, a number of iterations exceeds a first threshold, or a difference between a current correction coefficient and a prior correction coefficient in a prior iteration is smaller than a second threshold, etc.

In step 930, the processing engine 112 (e.g., the modification sub-unit 820) (e.g., the interface circuits of the processor 220) may obtain at least one test result associated with the candidate correction coefficient with a test vehicle having similar one or more features. In certain embodiments, the test vehicle has similar vehicle type, vehicle model, vehicle year, vehicle weight, engine power, and/or brake efficiency as the vehicle 130. In some embodiments, in order to obtain a more accurate correction coefficient, one or more tests (e.g., a braking test) may be performed on the test vehicle based on the candidate correction coefficient.

Take a specific test as an example, the processing engine 112 may determine a test initial speed (i.e., a speed at a time point when the processing engine 112 determines to start a braking process) of the test vehicle, a test start location (i.e., a location where the processing engine 112 determines to start the braking process), a test destination, a test distance between the test start location and the test destination, etc. Further, the processing engine 112 may determine a test target acceleration (e.g. according to formula (3)) based on the candidate correction coefficient and transmit the test target acceleration to a brake device of the test vehicle to prompt the brake device to adjust an actual acceleration of the test vehicle. Finally, the control component may control the test vehicle to stop at a parking location (i.e., an actual parking location). The processing engine 112 may further determine an offset distance between the actual parking location and the test destination. In certain embodiments, the goal is to minimize the offset distance.

In step 940, the processing engine 112 (e.g., the modification sub-unit 820) (e.g., the processing circuits of the processor 220) may determine a target correction coefficient by modifying the candidate correction coefficient based on the at least one test result. In certain embodiments, the target correction coefficient is determined as the correction coefficient to minimize the difference between the test results and the results from the simulation model. For example, the processing engine 112 may determine a modification value (e.g., ±0.5%˜±1%) of the correction coefficient based on the offset distance(s) associated with the at least one test result and modify the candidate correction coefficient based on the modification value. In certain embodiments, multiple test results are needed to improve the reliability of the modification.

In some embodiments, the correction coefficient may be self-adaptive. For example, in practice, the processing engine 112 may adaptively adjust the correction coefficient based on vehicle information, driving information, driving control information (e.g., a difference between an actual parking location and a predetermined parking location), or the like, or a combination thereof.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the simulation model may be further configured with wear-and-tear information (e.g., duration of use, mileage, exposure to harmful conditions, degree of maintenance, etc.) of the vehicle 130 or of vehicles used similarly as the vehicle 130 in general. In certain embodiments, the processing engine 112 may periodically update the target correction coefficient based on a newly performed simulation and/or one or more newly obtained test results.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

1. A system, comprising:
at least one storage medium including a set of instructions for determining a control parameter associated with a vehicle;
at least one processor in communication with the at least one storage medium, wherein when executing the set of instructions, the at least one processor is configured to cause the system to:
determine a first reference acceleration at a first time point;
determine a second reference acceleration at a second time point, wherein the first time point and the second time point are separated by a predetermined time period;
obtain a correction coefficient by using a simulation model, which is configured to simulate operation of the vehicle; and
determine a target acceleration at the second time point based on the first reference acceleration, the second reference acceleration, and the correction coefficient.

2. The system of claim 1, wherein the at least one processor is configured to cause the system further to:
transmit the target acceleration to a control component of the vehicle to prompt the control component to adjust an actual acceleration of the vehicle.

3. The system of claim 1, wherein to obtain the correction coefficient, the at least one processor is configured to cause the system further to:
determine a candidate correction coefficient based on the simulation model, which is configured with one or more features of the vehicle;
obtain at least one test result associated with the candidate correction coefficient with a test vehicle having similar one or more features; and
determine the correction coefficient by modifying the candidate correction coefficient based on the at least one test result.

4. The system of claim 3, wherein the one or more features of the vehicle include at least one of:
vehicle type,
vehicle model,
vehicle weight,
vehicle year,
engine power, or
brake efficiency.

5. The system of claim 3, wherein the simulation model is further configured with at least one of:
the predetermined time period,
a road condition, or
weather.

6. The system of claim 3, wherein the at least one test result associated with the test vehicle includes at least one of:
a test initial speed of the test vehicle, a test start location, a test destination, an actual parking location, or an offset distance between the test destination and the actual parking location.

7. The system of claim 1, wherein the correction coefficient is self-adaptive.

8. The system of claim 1, wherein,
to determine the first reference acceleration at the first time point, the at least one processor is configured to cause the system further to:
determine a first speed of the vehicle at the first time point,
obtain a first location of the vehicle at the first time point,
determine a first distance between the first location and a destination, and
determine the first reference acceleration at the first time point based on the first speed and the first distance; or
to determine the second reference acceleration at the second time point, the at least one processor is further directed to:
determine a second speed of the vehicle at the second time point,
obtain a second location of the vehicle at the second time point,
determine a second distance between the second location and a destination, and
determine the second reference acceleration at the second time point based on the second speed and the second distance.

9. A method implemented on a computing device having at least one processor, at least one storage medium, and a communication platform connected to a network, the method comprising:
determining a first reference acceleration at a first time point;
determining a second reference acceleration at a second time point, wherein the first time point and the second time point are separated by a predetermined time period;
obtaining a correction coefficient by using a simulation model, which is configured to simulate operation of the vehicle; and
determining a target acceleration at the second time point based on the first reference acceleration, the second reference acceleration, and the correction coefficient.

10. The method of claim 9, further comprising:
transmitting the target acceleration to a control component of the vehicle to prompt the control component to adjust an actual acceleration of the vehicle.

11. The method of claim 9, wherein the obtaining the correction coefficient by using the simulation model further includes:
determining a candidate correction coefficient based on the simulation model, which is configured with one or more features of the vehicle;
obtaining at least one test result associated with the candidate correction coefficient with a test vehicle having similar one or more features; and
determining the correction coefficient by modifying the candidate correction coefficient based on the at least one test result.

12. The method of claim 11, wherein the one or more features of the vehicle include at least one of:
vehicle type,
vehicle model,
vehicle weight,
vehicle year,
engine power, or
brake efficiency.

13. The method of claim 11, wherein the simulation model is further configured with at least one of:
the predetermined time period,
a road condition, or
weather.

14. The method of claim 11, wherein the at least one test result associated with a test vehicle includes at least one of:
a test initial speed of the test vehicle, an initial start location, a test destination, an actual parking location, or an offset distance between the test destination and the actual parking location.

15. The method of claim 9, wherein the correction coefficient is self-adaptive.

16. The method of claim 9, wherein,
the determining the first acceleration at the first time point includes:
determining a first speed of the vehicle at the first time point,
obtaining a first location of the vehicle at the first time point,
determining a first distance between the first location and a destination, and
determining the first reference acceleration at the first time point based on the first speed and the first distance; or
the determining the second acceleration at the second time point includes:
determining a second speed of the vehicle at the second time point,
obtaining a second location of the vehicle at the second time point,
determining a second distance between the second location and a destination, and
determining the second reference acceleration at the second time point based on the second speed and the second distance.

17. A non-transitory computer readable medium, comprising a set of instructions for determining a control parameter associated with a vehicle, wherein when executed by at least one processor, the set of instructions directs the at least one processor to perform acts of:
determining a first reference acceleration at a first time point;
determining a second reference acceleration at a second time point, wherein the first time point and the second time point are separated by a predetermined time period;
obtaining a correction coefficient by using a simulation model, which is configured to simulate operation of the vehicle; and
determining a target acceleration at the second time point based on the first reference acceleration, the second reference acceleration, and the correction coefficient.

18. The non-transitory computer readable medium of claim 17, the acts further comprising:
transmitting the target acceleration to a control component of the vehicle to prompt the control component to adjust an actual acceleration of the vehicle.

19. The non-transitory computer readable medium of claim 17, wherein the obtaining the correction coefficient by using the simulation model further includes:
determining a candidate correction coefficient based on the simulation model, which is configured with one or more features of the vehicle;
obtaining at least one test result associated with the candidate correction coefficient with a test vehicle having similar one or more features; and
determining the correction coefficient by modifying the candidate correction coefficient based on the at least one test result.

20. The non-transitory computer readable medium of claim 19, wherein the one or more features of the vehicle include at least one of:
vehicle type,
vehicle model,
vehicle weight,
vehicle year,
engine power, or
brake efficiency.
